(19) United States
(12) Patent Application Publication
(10) Pub. No.: US 2023/0166410 A1
(43) Pub. Date: Jun. 1, 2023

(54) A DEXTEROUS HAND WITH DETACHABLE FINGERS

(71) Applicant: SHENZHEN DORABOT INC., Shenzhen (CN)

(72) Inventors: Zheng XIE, Shenzhen (CN); Tao WANG, Shenzhen (CN)

(21) Appl. No.: 17/919,060

(22) PCT Filed: Apr. 27, 2021
(86) PCT No.: PCT/CN2021/090304

§ 371 Date: Oct. 14, 2022

(30) Foreign Application Priority Data
May 7, 2020 (CN) 202020731565.8

(51) Int. Cl. B25J 15/04; B25J 19/02

(52) U.S. Cl. CPC B25J 15/0475; B25J 19/02

(57) ABSTRACT

A finger-detachable dexterous hand includes a palm (10) and a plurality of fingers (20), wherein the palm (10) is provided with a plurality of finger mounting slots (101) for the fingers (20) to be inserted and mounted therein; and the dexterous hand further includes: locking assemblies (102) mounted in each of the finger mounting slots (101), and locking blocks (201) arranged at an inserting end of each of the fingers (20), wherein the locking assemblies (102) and the locking blocks (201) are connectible and lockable to each other for attaching and detaching the finger (20) to and from the finger mounting slot (101).

### CROSS REFERENCE TO RELATED APPLICATIONS

This application is a national stage filing under section 371 of Chinese Application No. CN202020731565.8 filed on May 07, 2020, which is published in Chinese on Mar. 30, 2021 as CN212825430U, the disclosure of which are hereby incorporated by reference in their entirety.

### TECHNICAL FIELD

The present invention relates to the technical field of dexterous hands, in particular to a dexterous hand with detachable fingers.

### BACKGROUND

In the prior art of dexterous hands, assembly and disassembly of fingers and a palm are troublesome. For example, in Chinese Application No. CN107538510A entitled a lightweight humanoid five-finger dexterous hand mechanism and Application No. CN105522587B entitled a bionic three-finger manipulator, multiple fingers and a palm are connected via relatively inflexible connections, such as a threaded connection, a keyed connection, and a pin connection, so the disassembly and assembly processes are tedious and time-consuming.

### SUMMARY

The technical problem to be solved by the present invention is to provide a dexterous hand with detachable fingers and a detachable palm, which aims at solving the technical problem of tedious assembly and disassembly of fingers and a palm of an existing dexterous hand.

To solve the above technical problem, the present invention provides a finger-and-palm-detachable dexterous hand, the dexterous hand including a palm and a plurality of fingers, wherein the palm is provided with a plurality of finger mounting slots for the fingers to be inserted and mounted therein; and the dexterous hand further including a locking assembly mounted in each finger mounting slot, and a locking block arranged at an inserting end of each finger, wherein the locking assembly and the locking blocks are connectible and lockable to each other for attaching and detaching the finger to and from the finger mounting slot. Optionally, each locking assembly includes a torsion spring and a pivot shaft, the torsion spring being rotatably provided around an outer periphery of the pivot shaft, and the pivot shaft being fixedly connected to an inner side of the finger mounting slot.

Optionally, one end of the torsion spring is hook-shaped, and the hook-shaped end is configured to be locked to the locking block by hooking.

Optionally, each locking block includes a guide part and a locking recess arranged at two opposite ends, and the guide part is arranged near the inserting end of the finger to guide a pivoting direction of the torsion spring; and the locking recess is provided with an opening facing away from the inserting end of the finger, which is configured for the hook-shaped end to be locked into or detached from the locking recess. Optionally, each locking block further includes a first inclined surface for guiding the hook-shaped end to move along the first inclined surface and be hooked in the locking recess.

Optionally, each locking block further includes a second inclined surface, and the second inclined surface and the first inclined surface intersect with the guide part for guiding the hook-shaped end to be detached from the locking block.

Optionally, two locking assemblies are symmetrically arranged in each finger mounting slot, and two locking blocks are correspondingly and symmetrically arranged on the surface of a housing of each finger.

Optionally, each locking block further includes an arc-shaped transition section arranged between the first inclined surface and the locking recess, and the arc-shaped transition section is configured to guide the hook-shaped end to slip from the first inclined surface into the locking recess.

Optionally, the finger mounting slot includes an upper slot section and a lower slot section fixedly connected to the upper slot section, and the upper slot section is fixedly connected to the palm; and the lower slot section is of a hollow cylindrical structure for accommodating at least part of a joint of the finger.

Optionally, the locking blocks are integrally formed with the finger, the finger is provided with flat surfaces parallel to an inserting direction, the flat surfaces are each provided with a recess, and each locking block is formed at a central position of the recess.

Optionally, each of the fingers includes a first joint section, a second joint section and a third joint section which are articulated in sequence, and the locking blocks are fixedly arranged on the third joint section; the first joint section includes a first sensor assembly; the second joint section includes a second sensor assembly, a first power mechanism and a control circuit board; the third joint section includes a second power mechanism; and the control circuit board is electrically connected to the first sensor assembly, the second sensor assembly, the first power mechanism, and the second power mechanism, respectively, so as to drive the first joint section to rotate relative to the second joint section via the first power mechanism and drive the second joint section to rotate relative to the third joint section via the second power mechanism according to a force on a surface of the first joint section detected by the first sensor assembly and a force on a surface of the second joint section detected by the second sensor assembly.

The dexterous hand with the detachable fingers and detachable palm provided by the present invention includes the palm and the plurality of fingers, wherein the palm is provided with the plurality of finger mounting slots for the fingers to be inserted and mounted therein; and the dexterous hand further includes: the locking assemblies mounted in each of the finger mounting slots, and the locking blocks arranged at the inserting end of each of the fingers, wherein the locking assemblies and the locking blocks are connectible and lockable to each other for attaching and detaching the finger to and from the finger mounting slot. In the technical scheme of the present invention, by respectively mounting the locking assemblies and the locking blocks on the palm and the fingers, the locking assemblies and the locking blocks can be locked, connected and mated to each other in the inserting direction of the fingers into the palm, and rapid assembly and disassembly of the dexterous hand can be realized, thereby greatly improving the application of modularization of the fingers; and moreover, locking of the locking assemblies and the locking blocks in the inserting direction of the fingers into the palm makes the fingers and the palm be firmly and reliably connected and prevents falling-off during operation of the dexterous hand.

### BRIEF DESCRIPTION OF DRAWINGS

In order to illustrate more clearly technical schemes in embodiments of the present invention or the related art, the accompanying drawings used in description of the embodiments or the related art will be briefly described below, and obviously, the accompanying drawings in the following description are only some embodiments of the present invention, and for those of ordinary skill in the art, other drawings can be derived on the basis of these drawings without any inventive effort.

FIG. 1 is a schematic diagram of fingers and a palm of a dexterous hand according to an embodiment of the present invention.

FIG. 2 is a schematic diagram of split structures of a finger mounting slot according to an embodiment of the present invention.

FIG. 3 is a schematic diagram of split structures of a locking assembly according to an embodiment of the present invention.

FIG. 4 is a schematic diagram of installation of a locking assembly according to an embodiment of the present invention.

FIG. 5 is a schematic diagram of a locking block according to an embodiment of the present invention.

FIG. 6 is a schematic diagram of a torsion spring according to an embodiment of the present invention.

FIG. 7 is a schematic diagram of positions of the torsion spring and the locking block in a start-of-rotation state according to an embodiment of the present invention.

FIG. 8 is a schematic diagram of positions of the torsion spring and the locking block in an unlocked state according to an embodiment of the present invention.

FIG. 9 is a schematic diagram of split structures of a finger according to another embodiment of the present invention.

### DETAILED DESCRIPTION

The specific implementation of the present invention will be further described with reference to the accompanying drawings. It should be noted here that the description of these implementations is intended to assist in understanding of the present invention, but is not intended to limit the present invention. Further, the technical features involved in each of the implementations of the present invention described below can be combined with each other as long as they do not conflict with each other.

In the description of the present invention, it should be noted that, descriptions relating to orientation, for example, orientation or positional relationships indicated by “center”, “up”, “down”, “left”, “right”, “vertical”, “horizontal”, “inside”, “outside”, etc. are based on the orientation or positional relationships shown in the accompanying drawings, and are to facilitate the description of the present invention and simplify the description only, rather than indicating or implying that the device or element referred to must have a specific orientation or be constructed and operated in a specific orientation, and therefore cannot be construed as limiting the present invention; and the terms “first”, “second” and “third” are for the purpose of description only and should not be construed as indicating or implying relative importance.

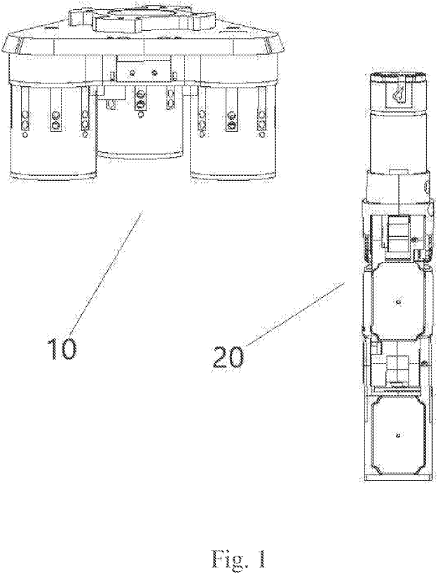

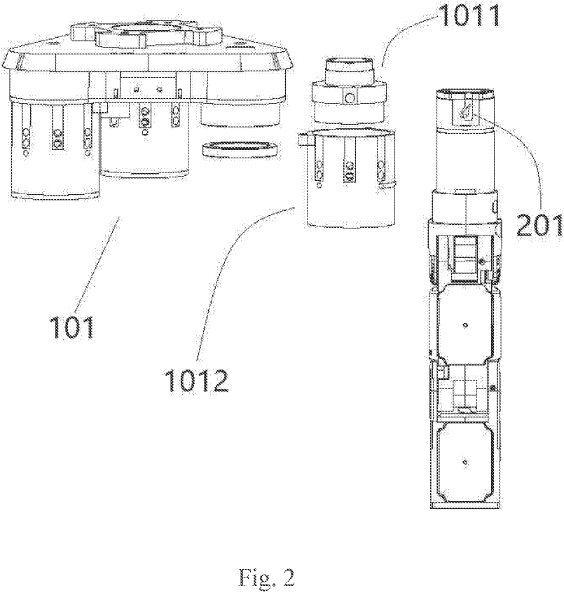

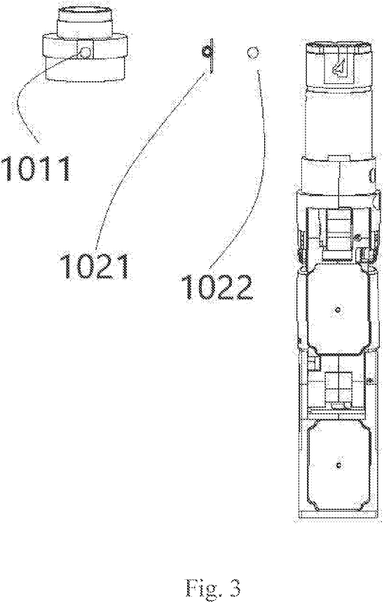

As shown in FIGS. 1-4, this embodiment provides a modular dexterous hand which includes a palm 10 and a plurality of fingers 20, wherein the palm 10 is provided with a plurality of finger mounting slots 101, each of which is configured to accommodate an inserting end (the other end is a finger tip end) of each finger 20. The inner side of each of the finger mounting slots 101 is provided with a locking assembly 102 for locking and preventing each finger 20 from falling off when the finger 20 is inserted and connected therein.

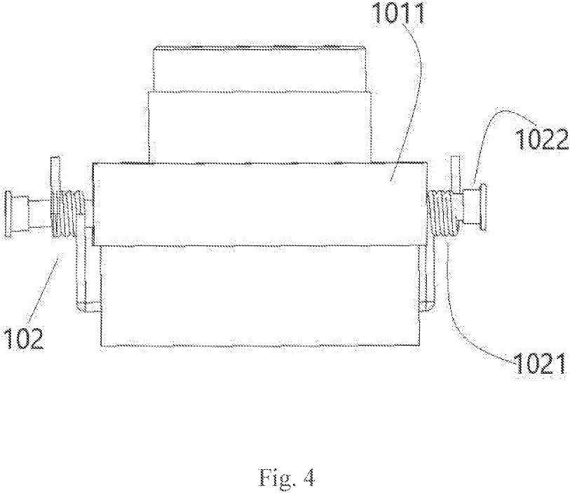

In this embodiment, each locking assembly 102 includes a torsion spring 1021 and a pivot shaft 1022, wherein the torsion spring 1021 is sleeved on the pivot shaft 1022, so that the torsion spring 1021 can pivot left and right around the pivot shaft 1022. The pivot shaft 1022 is connected to the finger mounting slot 101. Specifically, with reference to FIG. 4, the finger mounting slot 101 includes an upper slot section 1011 and a lower slot section 1012 (the torsion spring is mounted on the inner side of the upper slot section 1011), wherein the upper slot section 1011 is provided with a through hole, the pivot shaft 1022 is fixed to the upper slot section 1011 by passing the through hole, in which the manner of the fixing can be implemented by a threaded connection or other fixed connections. The lower slot section 1012 fixedly connected to the upper slot section is configured to be a hollow cylindrical structure 1011 to accommodate at least part of a joint section of the finger, so that when the finger is inserted into the finger mounting slot, the finger can be restricted to moving inside the slot, that is, the finger can only be plugged or unplugged or rotate in the slot.

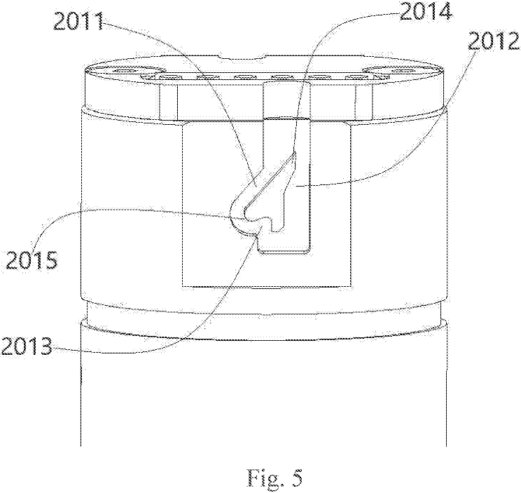

With reference to FIG. 5, each finger 20 includes at least one locking block 201 arranged at the inserting end thereof, the locking block 201 arranged at a circumferential surface of each finger includes a first inclined surface 2011, a second inclined surface 2012 and a locking recess 2013. The first inclined surface 2011 is configured to be disposed toward the inserting end to guide the torsion spring 1021 to move along it and slip into the locking recess 2013 to be hooked. The locking recess 2013 has an opening toward the finger tip end, so that when plugged in the locking recess 2013, the torsion spring 1021 is fixed in the direction of the inserting end while it also can move in the direction of the opening of the locking recess 2013. In other words, when the finger of the dexterous hand is plugged into the finger mounting slot, once the torsion spring is hooked in the locking recess, the finger is still movable in the plugging direction while it is fixed in the unplugging direction, thus ensuring that the finger is firmly fixed during operation and preventing the finger from falling off.

As shown in the figure, the second inclined surface 2012 is arranged on the opposite side of the first inclined surface 2011 for guiding the torsion spring 1021 to be detached from the finger. Specifically, a guide part 2014 is formed at a joint of the first inclined surface 2011 and the second inclined surface 2012 at the inserting end. The guide part 2014 is configured to guide the torsion spring 1021 to slip along the first inclined surface 2011 into the locking recess 2013 when the finger is inserted into the finger mounting slot, while it guides the torsion spring 1021 to be off the locking recess 2013 along the second inclined surface 2012 when the finger is unplugged from the finger mounting slot.

Further, the locking block 201 further includes an arc-shaped transition section 2015. The transition section 2015 is arranged between the first inclined surface 2012 and the locking recess 2013 for guiding the torsion spring 1021 to slip from the first inclined surface 2011 into the locking recess 2013. In addition, the surface of the arc-shaped transition section may be smoothed so that the torsion spring moves more smoothly thereon.

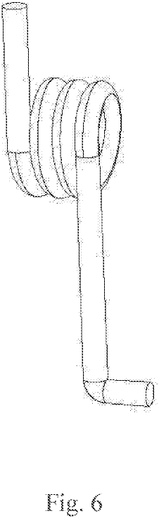

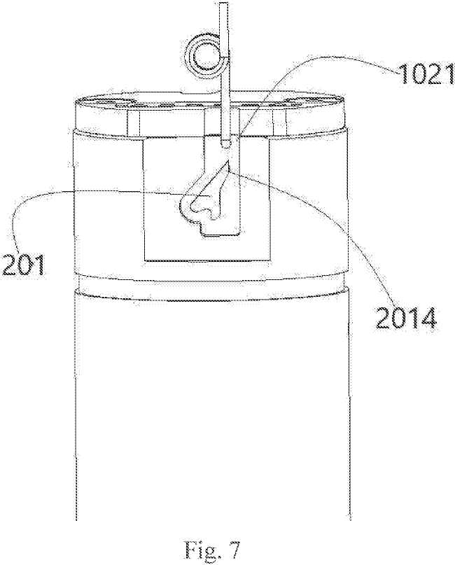

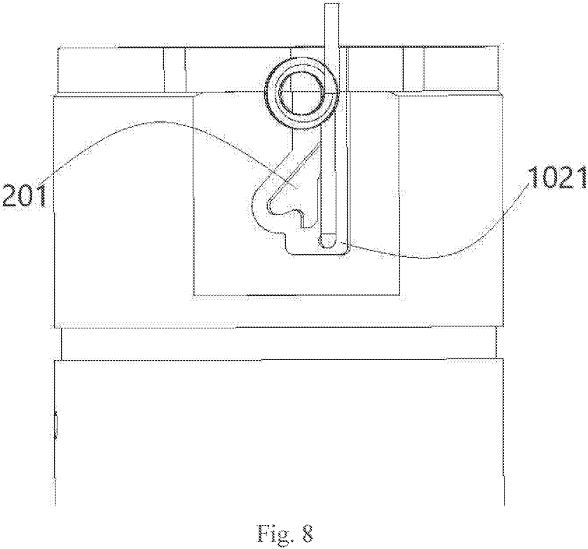

In this embodiment, as shown in FIGS. 6-8, one end of the torsion spring 1021 is hook-shaped and configured to be hooked inside the locking recess 2013 for locking and mating. Specifically, a hook-shaped end of the torsion spring 1021 is arranged inward in an axial direction of the pivot shaft 1022, that is, perpendicular to a pivoting plane of the torsion spring 1021. With reference to FIG. 7, an initial displacement position of the torsion spring 1021 is at the same level as the guide part 2014, that is, in the process of inserting the finger into the finger mounting slot, the hook-shaped end first butts against the guide part 2014, and then moves on the first inclined surface 2011. At this stage, the hook-shaped end pivots to the left, and there is a torsional force which gradually increases with the increase of a pivoting displacement. After the hook-shaped end moves to an end of the first inclined surface 2011, due to the torsional force, part of the displacement is restored to the right, so that the end is hooked in the locking recess 2013 to realize locking and assembly of the finger and the palm of the dexterous hand is completed. At this time, there is still a torsional force in the torsion spring 1021. When the finger need to be removed, the finger is pressed to move a short distance in the inserting direction, such that the hook-shaped end is detached from the locking recess 2013 from the opening of the locking recess. As there is still the torsional force in the torsion spring 1021, the torsion spring returns to the initial displacement position. At this time, the locking assemblies are in an unlocked state (as shown in FIG. 8). Then, the finger is pulled out of the finger mounting slot. Under guidance of the second inclined surface 2012, the hook-shaped end of the torsion spring 1021 pivots to the right, returns to the initial displacement position after being detached from the guide part 2014, and is detached from the finger, and thus disassembly of the finger and the palm of the dexterous hand is completed.

Further, as shown in FIGS. 7 and 8, the locking blocks may be integrally formed with the finger, a short section is intercepted in a circumferential direction of the finger to form a local flat surface, a recess portion is further cut out in the flat surface to form a relatively convex locking block at a central position of the recess, and the recess may be used as a movement path of the torsion spring.

In an embodiment, two locking assemblies are symmetrically arranged on each finger mounting slot, and correspondingly, two locking blocks are symmetrically arranged on the surface of a housing of each finger to match the locking assemblies for locking.

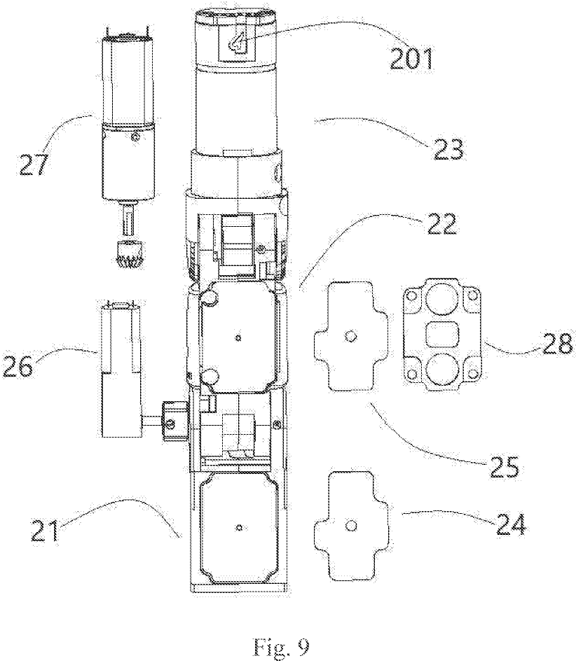

In another embodiment of the present invention, as shown in FIG. 9, the finger 20 is further provided with a plurality of sensors for detecting forces imposed on the surface of the finger. Specifically, each of the fingers 20 in this embodiment includes a first joint section 21, a second joint section 22 and a third joint section 23 in sequence, wherein the third joint section 23 is provided with the locking blocks 201 and configured to be inserted into the finger mounting slot; the second joint section 22 is articulated to the first joint section 21; and the third joint section 23 is articulated to the second joint section 22. The first joint section 21 is provided with a first sensor assembly 24. The second joint section 22 is provided with a second sensor assembly 25, a first power mechanism 26 and a control circuit board 28. The third joint section 23 is provided with a second power mechanism 27. The control circuit board 28 is electrically connected to the first sensor assembly 24, the second sensor assembly 25, the first power mechanism 26, and the second power mechanism 27 so as to drive the first joint section 21 to rotate (specifically, by an angle within ±90° in this embodiment) relative to the second joint section 22 via the first power mechanism 26 and drive the second joint section 22 to rotate (specifically, by an angle within ±90° in this embodiment) relative to the third joint section 23 via the second power mechanism 27 according to a force on the surface of the first joint section 21 detected by the first sensor assembly 24 and a force on the surface of the second joint section 22 detected by the second sensor assembly 25. In this way, each finger 20 is provided with the control circuit board 28 for independent control thereof, that is, each finger 20 has a control unit, which can realize functions including closed-loop control, sensor information processing, communications and other functions of the finger. The control unit within the finger can facilitate real-time control of the finger joints with higher efficiency, achieve higher precision of control, and features a high degree of modularization. In addition, the first joint section 21 is driven to rotate relative to the second joint section 22 via the first power mechanism 26, and the second joint section 22 is driven to rotate relative to the third joint section 23 via the second power mechanism 27, that is, each finger 20 is configured to utilize a full-drive scheme, which can accurately control movement of each joint and meet movement requirements of each joint. The first joint section 21, that is, a finger tip of the finger, is provided in a flat shape, so that the first joint section 21 can be inserted into a narrow gap for operation. For example, in a gift delivery scenario, the first joint section is inserted into a hand lifting gap of a gift box/handbag, and the first joint section is rotated to hook up the gift box/handbag and then deliver it to a consumer. For another example, the dexterous hand is used to grab goods piled on a supermarket shelf in boxes. As the gap between the goods is small, the dexterous hand can be controlled to insert the first joint section into the gap to take out the goods or turn over the goods.

The dexterous hand with the detachable fingers and detachable palm provided by the embodiment of the present invention includes the palm and the plurality of fingers, wherein the palm is provided with the plurality of finger mounting slots for the fingers to be inserted and mounted therein; and the dexterous hand further includes: the locking assemblies mounted in each of the finger mounting slot, and the locking blocks arranged at the inserting end of each of the fingers, wherein the locking assemblies and the locking blocks are connectible and lockable to each other for attaching and detaching the finger to and from the finger mounting slot. In the technical scheme of the present invention, by respectively mounting the locking assemblies and the locking blocks on the palm and the fingers, the locking assemblies and the locking blocks can be locked, connected and mated to each other in the inserting direction of the fingers into the palm, and rapid assembly and disassembly of the dexterous hand can be realized, thereby greatly improving the application of modularization of the fingers; and moreover, locking of the locking assemblies and the locking blocks in the inserting direction of the fingers into the palm makes the fingers and the palm be firmly and reliably connected and prevents falling-off during operation of the dexterous hand.

Although implementations of the present invention have been described in detail above with reference to the accompanying drawings, the present invention is not limited to the described implementations. It should be understood by those of ordinary skill in the art that various changes, modifications, substitutions, and variations made to these embodiments without departing from the principles and concepts of the present invention still fall within the scope of the present invention.

1. A finger-and-palm-detachable desterous hand, comprising a palm and a wherein plurality of fingers, whereinthe palm is provided with a plurality of finger mounting slots for the fingers to beinserted and mountedthererein; and futher comprising a locking assembly mounted in each finger mounting slot, and a locking block arranged at an inserting end of each finger, wherein the locking assembly and the locking block are connectible and lockable to each other for attaching and detaching the finger to and from the finger mounting slot.

2. The dexterous hand of claim 1, wherein each locking assemble composes a torsion spring and a pivot shaft, the torsion spring being rotatably provided around an outer periphery of the pivot shaft, and the pivot shaft being fixedlyconnected to an inner side of the finger mounting slot.

3. The dexterous hand of claim 2, wherein one end of the torsion spring is hook-shaped, and the hook-shaped end is configured to be locked to the locking block by hooking.

4. The dexterous hand of claim 3, wherein each locking block comprises a guide part and a locking recess arranged at two opposite ends, and the guide part is arranged near the inserting end of the fingers to guide a pivoting direction of the torsion spring; and the locking guide a pivoting direction of the torsion spring; and the locking recess recess is provided with an opening facing away from the inserting end of the finger, which is configured for the hook-shaped end to be locked into or detached from the locking recess.

5. The dexterous hand of claim 4, wherein each locking block further comprises a first inclined surface for guiding the hook-shaped end to move along the first inclined surface and be hooked in the locking recess.

6. The dexterous hand of claim 5, wherein each locking block further comprises a second inclined surface, and the second inclined surface and the first inclined surface intersect at the guide part for guiding the hook-shaped end to be detached from the locking block.

7. The dexteroushand of claim 5, wherein each locking block further comprises an arc-shaped transition section arranged between the first inclined surface and the locking recess,and the arc-shaped transition section is configured to guide the hook-shaped end to slip from the first inclined surface into the locking recess.

8. The dexterous hand of claim 1, wherein the finger mounting slot comprises an upper slot section and a lower slot section fixedly connected tothe upper slot section, and the upper slot section is fixedly connected to the palm; and the lower slot section is configured to be > a hollow cylindrical structure for accommodating at least part of a joint of the finger.

9. The dexterous hand of claim 1, wherein the locking blocks are integrally formed with the finger, the finger is provided with flat surfaces parallel to an inserting direction, the flat surfaces are each provided a recess, and each locking block is formed at a central position of the recess.

10. The dexterous hand of claim 1, wherein each of the fingers comprises a first joint section, a second joint section and a third joint section which are articulated in sequence, and the locking blocks are fixedly arranged on the third joint section;
the first joint section comprises a first sensor assembly; section
the second joint section comprises a second sensor assembly, a first power mechanism and a control circuit board;
the third joint section comprises a second power mechanism; and
the control circuit board is connected to the first sensor assembly, the second sensor electrically assembly, the first power mechanism, and the second power mechanism respectively, so as to drive the first joint section to rotate relative to the second joint section via the first power mechanism and drive the second joint section to rotate relative to the third joint section via the second power mechanism according to a force on a surface of the first joint section detected by the first sensor assembly and a force on a surface of the second joint section detected by the second sensor assembly.

11. The dexterous hand of claim 2, wherein each of the fingers comprises a first joint section, a second joint section and a third joint section which are articulated in sequence, and the locking blocks are fixedly arranged on the third joint section;
the first joint section comprises a first sensor assembly;
the second joint section comprises a second sensor assembly, a first power mechanism and a control circuit board;
the third joint section comprises a second power mechanism; and
the control circuit board is electrically connected to the first sensor assembly, the second sensor assembly, the first power mechanism, and the second power mechanism respectively, so as to drive the first joint section to rotate relative to the second joint section via the first power mechanism and drive the second joint section to rotate relative to the third joint section via the second power mechanism according to a force on a surface of the first joint section detected by the first sensor assembly and a force on a surface of the second joint section detected by the second, sensor assembly.

12. The dexterous hand of claim 3, wherein each of the fingers comprises a first jointsection, a second joint section and a third joint section which are articulated in sequence, and the locking blocks are fixedly arranged on the third joint section;
the first joint section comprises a first sensor assembly;
the second joint section comprises a second sensor assembly, a first power mechanism and a control circuit board;
the third joint section comprises a second power mechanism; and
the control circuit board is electrically connected to the first sensor assembly, the second; sensor assembly,the first power mechanism, and the second power mechanism respectively, so as to drive the first joint section to rotate relative to the second joint section via the first power mechanism and drive the second joint section to rotate relative to the third joint section via the second power mechanism according to a force on a surface of the first joint section detected by the first sensor assembly and a force on a surface of the second joint section detected by the second sensor assembly.

13. The dexterous hand of claim 4, wherein each of the fingers comprises a first joint section, a second joint section and a third joint section which are articulated in sequence, and the locking blocks are fixedly arranged on the third joint section;
the first joint section comprises a first sensor assembly;
the second joint section comprises a second sensor assembly, a first power mechanism and a control circuit board;
the third joint section comprises a second power mechanism; and the control circuit board is electrically connected to the first sensor assembly, the secondsensor assembly, the first power mechanism, and the second power mechanism respectively, so as to drive the first joint section to rotate relative to the second joint section via the first power mechanism and drive the second joint section to rotate relative to the third joint section via the second power mechanism according to a force on a surface of the first joint section detected by the first sensor assembly and a force on a surface of the second joint section detected by the second sensor assembly.

14. The dexterous hand of claim 5, wherein each of the fingers comprises a first joint section, a second joint section and a third joint section which are articulated in sequence, and the locking blocks are fixedly arranged on the third joint section;
the first joint section comprises a first sensor assembly:
the second joint section comprises a second sensor assembly, a first power mechanism and a control circuit board;
the third joint section comprises a second, power mechanism; and the control circuit board is electrically connected to the first sensor assembly, the second sensor assembly, the first power mechanism, and the second power mechanism respectively, so as to drive the first joint section to rotate relative to the second joint section via the first power mechanism and drive the second joint section to rotate rellative to the third section via the second power mechanism according to a force on a surface of the first joint section detected by the first sensor assembly and a force on a surface of the second joint section detected by the second sensor assembly.

15. The dexterous hand of claim 6, wherein each of the fingers comprises a first a second joint section and a third joint section which are articulated in sequence, and the locking block are fixedly arranged on the third joint section;
the first joint section comprises a first sensor assembly;
the second joint section comprises a second sensor assembly, a first power mechanism and a control circuit board;
the third joint section comprises a second, power mechanism; and
the control circuit board is electrically connected to the first sensor assembly, the second sensor assembly, the first power mechanism, and the seeend power mechanism respectively, so as to drive the first joint section to rotate relative to the second joint section via the first power mechanism and drive the second joint section to rotate relative to the third joint section via the second power mechanism according to a force on a surface of the first joint section detected by the first sensor assembly and a force on a surface of the second joint section detected by the second sensor assembly.

16. The dexterous hand of claim 7, wherein each of the fingers comprises a first joint section, a second joint section and a third joint section which are articulated in sequence, and the locking blocks are fixedly arranged on the third joint, section;
the first joint section comprises a first sensor assembly;
the second joint section comprises a second sensor assembly, a first power mechanism and a control circuit board;
the third joint section comprises a second power mechanism; and
the control circuit board is electrically connected to the first sensor assembly the second sensor assembly, the first power mechanism, and the second power mechanism respectively, so as to drive the first joint section to rotate relative to the joint section via the first power mechanism and drive the joint section to rotate relative to the third joint section via the second power mechanism according to a force on a surface of the first joint section detected by the first sensor assembly and a force on a surface of the second joint section detected by the second sensor assembly.

17. The dexterous hand of claim 8, wherein each of the fingers comprises a first joint section, a second joint section and a third joint section which are articulated in sequence, and the locking blocks are fixedly arranged on the third joint section;
the first joint section comprises a first sensor assembly;
the second joint section comprises a second sensor assembly, a first power mechanism and a control circuit board;
the third joint section comprises a second power mechanism; and
the control circuit board is electrically connected to the first sensor assembly, the second sensor assembly, the first power mechanism, and the second power mechanism respectively, so as to drive the first joint section to rotate relative to the second joint section via the first power mechanism and drive the second joint section to rotate relative to the third joint via the second power mechanism according to a force on a surface of the first joint section detected by the first sensor assembly and a force on a surface of the second joint section detected by the second sensor assembly.

18. The dexterous hand of claim 9, wherein each of the fingers comprises a first joint section, a second joint section and a third joint section which are articulated in sequence, and the locking blocks are fixedly arranged on the third joint section;
the first joint section comprises a first sensor assembly;
the second joint section comprises a second sensor assembly, a first power mechanism and a control circuit board;
the third joint section comprises a second power mechanism; and
the control circuit board is electrically connected to the first sensor assembly, the second sensor assembly,the first power mechanism, and the second power mechanism respectively, so as to drive the first joint section to rotate relative to the second joint section via the first power mechanism and drive the second joint section to rotate relative to the third joint section via the second power mechanism according to a force on a surface of the first joint section detected by the first sensor assembly and a force on a surface of the second joint section detected by the second sensor assembly.
